(19) United States
(12) Patent Application Publication
(10) Pub. No.: US 2008/0275992 A1
(43) Pub. Date: Nov. 6, 2008

(54) SYSTEM AND METHOD OF MANAGING CONNECTIONS BETWEEN A COMPUTING SYSTEM AND AN AVAILABLE NETWORK USING A CONNECTION MANAGER

(75) Inventors: Alain Basty, Prades-Le-Lez Languedoc (FR); David Navarro, Montpellier Languedoc (FR); Tristan Pateloup, Clapiers Languedoc (FR)

Correspondence Address: BERRY & ASSOCIATES P.C., 9255 SUNSET BOULEVARD, SUITE 810, LOS ANGELES, CA, 90069, US

(73) Assignee: ACCESS SYSTEMS AMERICAS, INC., Sunnyvale, CA (US)

(21) Appl. No.: 12/025,054

(22) Filed: Feb. 4, 2008

Related U.S. Application Data
(63) Continuation-in-part of application No. 11/055,491, filed on Feb. 9, 2005.
(60) Provisional application No. 60/888,534, filed on Feb. 6, 2007.

(51) Int. Cl. G06F 15/16

(52) U.S. Cl. 709/227

(57) ABSTRACT

In one aspect, a method of enabling an execution thread of an application running on a communication device to access a communication service is provided. The method includes selecting a connection profile that supports the communication service and attaching the execution thread to a data channel associated with the connection profile. In another aspect, a computing device is provided capable of running an application having one or more execution threads and communication capability. The computing system or device comprises connection management logic including a database for storing a plurality of connection profiles, server logic adapted to receive a request from the application for a communication service, select a connection profile from the database that supports the requested communication service, and attach one of the one or more execution thread of the application to a data channel associated with the connection profile, and a user interface enabling user input for modifying the plurality of connection profiles.

### PRIORITY CLAIM

The present invention claims the benefit under 35 U.S.C. § 119(e) of U.S. Provisional Patent Application No. 60/888,534 filed on Feb. 6, 2007, the contents of which are incorporated herein by reference and are relied upon here.

### OTHER RELATED APPLICATIONS

In addition, the present application is a continuation-in-part of U.S. patent application Ser. No. 11/055,491 (Attorney Docket No. 4004.Palm.PSI), entitled “A System and Method of Managing Connection Between a Mobile Device and an Available Network”, filed on Feb. 9, 2005, which is incorporated by reference in its entirety.

### BACKGROUND OF THE INVENTION

1. Field of the Invention

The present invention relates to the field of establishing computing communication between computing devices and available communication networks (including dedicated connections) at different locations. In particular, the present invention applies to computing devices such as mobile devices (e.g. laptops, cellular telephones, and personal digital assistants (PDAs) and other client devices having limitations in terms of processing power and/or display screen size.

2. Introduction

As processor, memory and other computing components have become ever smaller and less costly, newer generations of computing devices have become available beyond conventional desktop systems. The newer generations of computing devices include mobile computing units such as personal digital assistants and smart cell phones, but also include a wide range of additional devices and appliances having embedded processing and data communication capability.

These computing devices are generally designed to be able to communicate with a data network, via one or more wired or wireless communication links. It is not uncommon for a single user to have an computing device connectable to one or more other computer systems and/or servers, such as by wireless connections (Bluetooth, IrDA), local area networks (LAN, direct or wireless (WIFI—802.11 and GPRS (General Packet Radio Service) and traditional dial-up modems (e.g. PPP (Point-to-Point protocol), USB, GSM (Global System for Mobile Communication) etc.). A number of different communications protocols exist for connecting computing devices to one another. Typically, most devices are configured to facilitate only a particular type of connection selectable manually by the user.

What is needed in the art are improved connection schemes and a mobile device configured that is configured to automatically connect it to a best available network at a particular location.

### SUMMARY OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

In a first aspect, the present invention provides a method of enabling an execution thread of an application running on a computing system having communication capability and a plurality of communication software modules to access a communication service that enables data communication between the computing system and a network. In one or more embodiments, the method includes selecting a connection profile including a sequence of references to one or more of the plurality of communication software modules for setting up a connection that uses the communication service and attaching the execution thread to a data channel associated with the connection profile, wherein the selected connection profile defines steps for setting up the connection that uses the communication service.

In a second aspect, the present invention provides a computing system or device having processing capability for running an application having one or more execution threads and communication capability. In one or more embodiments, the computing device comprises connection management logic including i) a database for storing a plurality of connection profiles and ii) server logic adapted to receive a request from the application for a communication service, select a connection profile from the database that supports the requested communication service, and attach one of the one or more execution thread of the application to a data channel associated with the connection profile. The computing device further includes a user interface enabling user input for modifying the plurality of connection profiles.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof, which are illustrated in the appended drawings. The present invention will be described and explained with additional specificity and detail through the use of the following drawings.

FIG. 1 is a block diagram of an exemplary computing device in which the various aspects of the present invention may be practiced.

FIG. 2 is a block diagram of an exemplary connection manager in accordance with an embodiment of the present invention.

FIG. 3 is a flow chart of an exemplary method of connecting a connection profile according to an embodiment of the present invention.

### DETAILED DESCRIPTION OF THE INVENTION

Various embodiments of the invention are described in detail below. While specific implementations involving computing mobile devices (e.g., portable computers) are described, it should be understood that the description here is merely illustrative and not intended to limit the scope of the various aspects of the invention. A person skilled in the relevant art will recognize that other components and configurations may be easily used or substituted than those that are described here without parting from the spirit and scope of the invention.

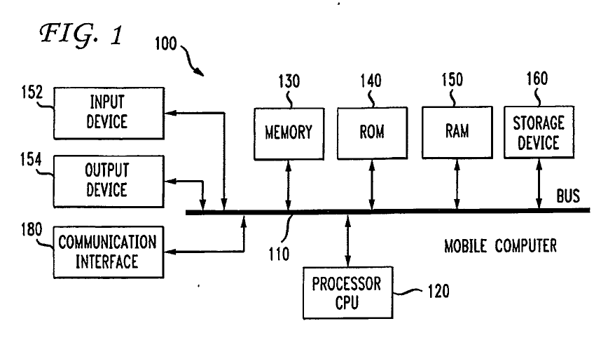

FIG. 1 is a block diagram of a computing system or device having a processor (i.e., computing ability) in which the various aspects of the preferred embodiments of the present invention may be implemented. Those skilled in the art will appreciate that the various aspects or features of the present invention may be practiced with multiprocessor-based systems, microprocessor-based or programmable consumer computings, network PCs, minicomputers, mainframe computers and the like. The various aspects of the invention may also be practiced in distributed computing environments where tasks are variously performed by remote processing devices that are linked through a communications network. While the present invention is applicable across a wide variety of other platforms and devices, an exemplary embodiment of the present invention is described below with respect to a mobile computing device (‘mobile device’), e.g. a personal digital assistant (PDA) such as the Palm® series of handheld devices.

The computing device may be configured to execute instructions, such as program modules, which may include routine programs, objects, components, data structures, etc., that perform particular tasks or implement particular abstract data types or functions. In a distributed computing environment, program modules may be located in both local and remote memory storage devices.

With continued reference to FIG. 1, an exemplary portable or mobile computing device 100 includes a central processing unit (CPU) 120. A system memory 130 and various other system components are coupled by a system bus 110 to the CPU 120. The system bus 110 may be any of several types of bus structures including a memory bus or memory controller, a peripheral bus, or a local bus using any of a variety of bus architectures. The system memory 130 includes read only memory (ROM) 140 (typically comprising flash memory as in a PDA) to store operating system and application code, and random access memory (RAM) 150 to store temporary data for applications.

The computing device 100 also includes a basic input device 152, such as a keyboard or a touch screen that is used to receive data from a user. The computing device 100 further includes a basic output device 154, such as a display screen, to display user interfaces (UI) and other information to the user. A storage device 160 such as a hard drive may also be included.

Lastly, the computing device 100 includes a communication interface 180 to communicate with a communication network. Examples of a communication interface 180 include wireless communications hardware (e.g., GPRS (General Packet Radio Service), WiFi, etc.) and direct communications hardware (e.g., dial-up modem and direct LAN connection).

In the example where the computer system 100 comprises a mobile device, a communication link may be coupled to a cradle or cable dock (not shown) associated with the mobile device for receiving and initiating communication with computer system 100 over a communication line. The cradle provides an electrical and mechanical communication interface or link between the computing device 100 and a network for two-way communications. In one exemplary embodiment, the communication link including the cradle and the line may comprise a serial communication link or a USB link. The computing device 100 may also contain a wireless infrared communication mechanism for sending and receiving information to or from other devices with which communication is desired.

In one embodiment of the present invention, the communication link may be a serial communication port, but may also be any of a number of well-known communication standards and protocols, e.g., parallel, SCSI, Firewire (IEEE 1394), Ethernet, etc. The computing device 100 may also include one or more other wireless communication mechanisms, e.g., cellular phone, Bluetooth and/or wireless LAN (e.g., IEEE 802.11), for instance, all of which may be used to establish the communication link between the portable computer system 100 and the host computer or with the Internet directly.

The ROM 140 may store operating system and application code that defines an Input/Output system based on a framework for establishing communication. In some embodiments, the STREAMS framework is employed which is an established framework for building modular communication protocols. Alternatively, other network architectures known to those skilled in the art may be used instead of a STREAMS framework. In accordance with the embodiment disclosed here, when an application that is running on the computing device issues a request to initiate a connection, STREAMS drivers and modules known to those skilled in the art are opened and linked together. For example, communication may be initiated by opening a serial port, which is opened by opening a STREAMS driver. A connection to the Internet may be established by opening and linking several drivers or modules, depending on the technologies that are used to access the Internet. The STREAMS framework and the IOS (Input/Output System) do not necessarily define a service or library that assists the applications and the system to build STREAMS stacks, and therefore, in some embodiments, the applications and system do not directly interact with STREAMS drivers and modules.

Moreover, in some embodiments of the present invention, useful connection information (for example: serial port baud rates, PPP passwords, dial-up phone number, etc) is stored. To establish connections effectively, this information is stored such that it may be readily accessed. This information may also be stored such that it may be easily edited by the user.

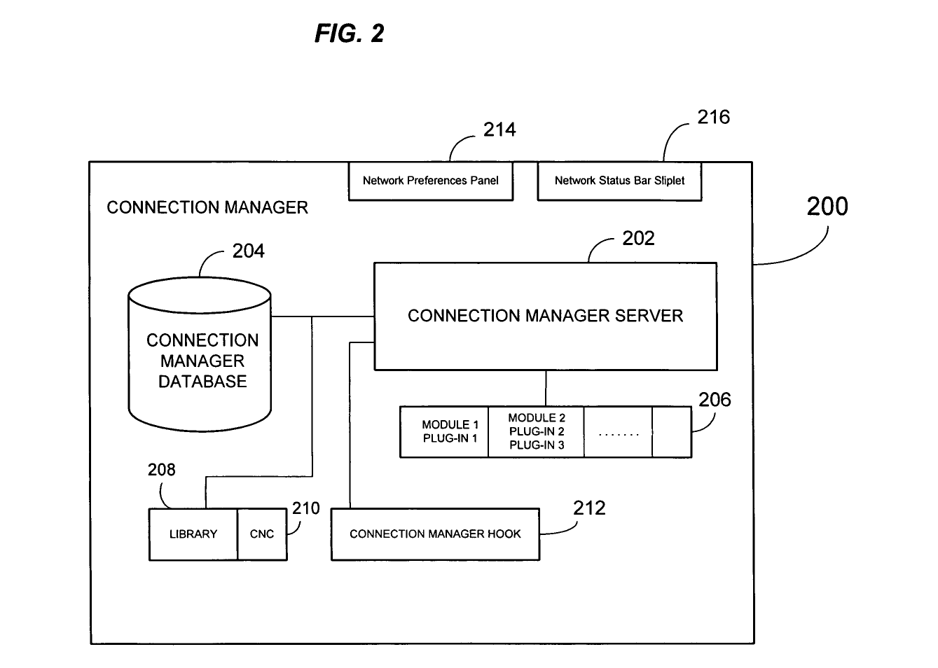

Referring to FIG. 2, a connection manager 200 is executed by the processor 120 to control the communication interface 180. The connection manager 200 is a mid-level component which interfaces between applications, other middleware and low level communication components and services (e.g., Linux components). The connection manager 200 conducts operations on two ‘levels’, an application level, at which the connection manager 200 interacts with the applications to which it interfaces, and a process level, at which the connection manager 200 interacts with lower level components. One of the major functions of the connection manager 200 is to seamlessly establish connections based on application and user needs. The connection manager 200 takes the connectivity environment (e.g., whether signal reception is sufficient) into account by monitoring connection profiles that are currently available and enables allows the computing device 100 to adapt seamlessly as it moves through areas of varying connectivity. In this manner, the process of establishing connections based on connectivity environment and user needs is automated and handled by the connection manager 200.

In some embodiments, the connection manager 200 includes a connection manager server 202 and a connection database 204 and a group of plug-in modules 206. In alternative embodiments, the connection database 204 may be a separate component. The connection manager 200 may be based on a Linux operating system platform.

The connection manager server 202 manages connections and communicates between the application layer and lower level components including Linux communication protocols and system hardware. The connection manager server 202 is communicatively coupled to the connection manager database 204 which includes a plurality of connection profiles that the connection manager server 202 employs to establish a network connection. The connection manager server also performs write operations to the connection manager database 204 including the creation and/or deletion of connection profiles in the connection manager database 204. In some embodiments, the connection manager server also monitors and controls currently-utilized (‘connected’) profiles, and is adapted to disconnect designated connected connection profiles as needed. The connection manager server 202 may also manage security information.

When connecting, disconnecting or controlling connection profiles, the connection manager server 202 may call the plug-in modules 206 comprise program code for implementing specific processes used in configuring, establishing and/or controlling a connection. For example, an IP (Internet Protocol) plug-in may be used to assign an IP address to interfaces and to create default routes while a PPP (Point-to-Point Protocol) plug-in may be used to run execute a point-to-point protocol connection process. Plug-in modules 206 may reside in standard directories and may make use of standard Linux commands such as pppd (Point-to-Point Protocol Daemon) and udhcpc (Very Small Dynamic Host Configuration Protocol), or may directly call shell scripts containing a series of commands. A shell script or command called by a plug-in 206 may be invoked to retrieve information (‘results’) which are then delivered back to the connection manager server 202. For example, a shell script associated with the udhcpc command may be invoked to retrieve a local IP (Internet Protocol) address given by the DHCP server.

The connection manager server 202 may run as a privileged user (root) so as to be able to configure network and other communication components, and may commence at Linux boot time, by the init program. Upon execution, the connection manager server 202 first enumerates and then dynamically loads plug-in modules 206.

The connection manager database 204 stores a number of different records including plug-ins, interfaces, edges, connection profiles, templates and links. Each plug-in in the plug-in modules 206 has an associated record in the connection manager database 204. Each of the plug-ins, in turn, may define anchors or interfaces where connection profiles may be attached. For example, network connection profiles may be attached under a “!NetOut” plug-in. Interface records include the anchors of the plug-ins but may also be used to group several plug-ins/interfaces under a single identifier. Edges are records that are used to form a connection between plug-ins and interfaces. The connection profiles themselves include a sequence of references to the plug-ins and interfaces defining how to connect a device or a network interface. The connection profiles may include parameters for each reference and may be implemented in the form of a string. Templates are records used to create new profiles and links are objects that are used to reference other objects.

The connection manager database 204 may be implemented as a Linux regular file which may be protected by Linux rights (e.g., readable and writable by root). In some embodiments, the connection manager 200 is configured to ensure that the connection manager server 202 is the only process that accesses the connection manager database 204. Sensitive information in connection profiles such as passwords may be handled by a security vault. In addition, to accelerate searches, the connection manager server 202 may keep in memory a cache of the system names and IDs of all connection profiles.

The connection manager also includes a library 208 that provides facilities to application and services via an application program interface (API), a Linux command ‘cnc’ 210 that is used by scripts to communicate with the connection manager server 202 (e.g., to send parameters of a connection such as a local IP address), and a connection hook 212 that allows users to override automatic connection and sharing mechanisms.

The plug-in modules 206 contain code related to managing one or more communication devices or protocols and may define several individual plug-ins. For example, the plug-in modules 206 may define a TCP/IP plug-in, a PPP plug-in, a Bluetooth plug-in, etc. Plug-in modules 206 may be identified by a file name, an internal name, a version, an entry point, a list of plug-ins contained in the module and UI (User Interface) objects common to all the plug-ins in the module. The plug-ins modules may be implemented in the form of Linux shared-code modules or libraries.

An individual plug-in, e.g., Plug-in 1, Plug-in 2 may be defined by a (1) system-unique name and an ‘internationalized’ name (e.g., Bluetooth), (2) a connection call back that cooperates with Linux functions to start services or protocols and open devices, (3) a control call back for managing disconnection, dynamic availability, priority, modification requests, and (4) additional optional configuration parameters.

The connection manager server 204 may enumerate the plug-ins in each plug-in module (e.g., plug-in 1 in module 1, plug-in 2 in module 2) upon initialization (boot time) and may load the plug-in modules 206 in an arbitrary order. In addition, the connection manager server 204 may issue ‘requests’ to the plug-in modules 206 to register by calling the plug-in module entry points. Plug-ins modules 206 may delay the registration process to resolve problems caused by plug-in dependencies. For example, when multiple plug-in modules 206 have the same identification, the newest version may be used, allowing for updating of plug-in modules 206 residing in ROM with updated version in RAM.

After a plug-in module (e.g., module 1) has been loaded in a process, the connection manager server 202 calls the module entry point with commands to initialize and register. If the module is unable to complete registration, a “registration_done” flag is set to false. In this manner, the connection manager server 202 is made aware that the plug-in module did not successfully register so that the connection manager server knows to call the module entry point again if the plug-ins within the module are called upon. Once a plug-in module is registered, each plug-in of the module has an associated record in the connection manager database 204 and a unique database ID.

In general, when an application issues requests to establish a connection with a network or device, the application selects a suitable connection profile, routes network traffic to the selected profile and uses DNS servers associated with the selected connection profile (all performed whether or not another connection is active). According to the present invention, data channels enable applications and services to take advantage of the suitable connection profiles. An application program interface is provided which allows application to access the connection manager 202. Each application thread being executed can open a data channel or ‘bind’ to an already open data channel. At any given time, a thread can be bound to either one data channel or not bound to any data channel. A thread can also switch from one data channel to another data channel at any time. This is facilitated by the use of a profile tag that records the services supported by a given connection profile. Applications requiring specific services may be thereby directed to use a suitable connection profile. If no suitable profile exists to specifically facilitate the service, the application may fallback on general connection profiles (i.e., profiles with no tags).

To tag network connection profiles with one or more services, a licensee or carrier may add a ‘srv0’ parameter to the NetOut? plug-ins of the connection profiles. In one embodiment this can be performed when the connection profile is created with ‘cnc’ commands alp_cnc_profile_decode( ), or later with alp_cnc_profile_set_parameters( ). The ‘srv0’ parameter value may be a 32-bit integer where each bit represents a service. A connection profile having a tag value of zero or no tag at all may be presumed to be a general connection profile. The list of supported services and links can be extended. For example, if more than 32 kinds of services are requested, the list can be extended by adding other parameters (e.g., ‘srv1’, ‘srv2’).

The connection profiles may be ordered in terms of priority according to the link they use. In one embodiment of the present invention, the connection profiles may be numerically ranked as follows:

| | |
|---|---|
| Ethernet | 140 |
| USB | 120 |
| Wifi 802.11 | 100 |
| Bluetooth BNEP | 80 |
| Telephony Packet | 60 |
| Switched | |
| Telephony Circuit | 40 |
| Switched | |

However, it is noted that the priority of a connection profile can be modified by the user through the connection manager 200. A separate list is made of connections profiles to be followed in trying to establish connections. This list takes into profile priority as well as data received from plug-ins such as link status. An example of adjustment to priority would be according a wireless or cellular connection profile a higher priority than Ethernet connection (usually the reverse) if mobility is a more important consideration than power consumption.

Data traffic routing is another major function of the connection manager 200. When a thread is connected to a data channel, a plug-in may create a sub-table in a main routing table that defines a subnet rule for delivering traffic through an interface and a default gateway for the connected interface. The threads are automatically bound to the channel which they open. A plug-in can also configure a rule in the main routing table to associate traffic explicitly to use the sub-table associated with the interface. This allows applications to bind their sockets to the interface and to use the correct default gateway. A thread can be bound to an established data channel. This causes future socket calls in the thread to bind to the interface associated with the bound data channel. This will allow for all the traffic of the thread to be routed through the correct interface and gateway. Applications that run multiple threads can bind each thread to a different data channel. An application may request a specific channel for well-known servers; this may be accomplished by adding a rule in the main routing table that indicates that a particular channel interface is to be used when contacting a specific host.

The connection manager server monitors the DNS servers associated with the various data channels that are in use. At the time a data channel is connected, a plug-in may bind each DNS server to the data channel. This ensures that DNS requests to specific DNS servers are routed to the proper interface using the correct gateway. When a thread is bound to a data channel, a standard resolver in the thread may use the DNS servers and domains associated with the data channel. This is accomplished by changing, after initialization, a _res thread variable used by the standard resolver.

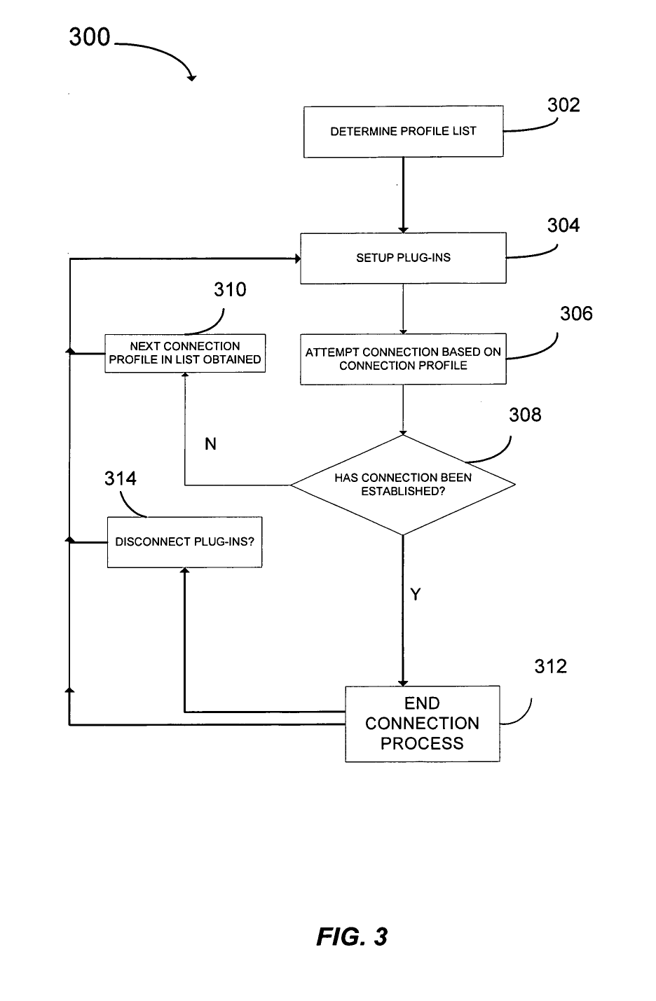

FIG. 3 is a flow chart of an exemplary method 300 of connecting a connection profile according to an embodiment of the present invention. In a first step 302, the connection manager 200 (shown in FIG. 2) determines a connection profile list. In a following step 304, a profile is selected from the list and the plug-ins of the profile are setup. In step 306, a connection is attempted using the selected connection profile. In step 308, it is determined if the attempted connection has been established. If, in step 308 a connection has not been established, the next connection profile in the list is obtained in step 310. The process then cycles back to step 304 in which the next connection profile is selected and the plug-ins of the new connection profile are configured. If a connection has been successfully established in step 308, the connection process ends in step 312. Thereafter, in step 314, the plug-ins of the established profile are disconnected and the process cycles back to step 302. If there is a command to connect a new or additional connection profile, the process cycles back to step 302 to determine the profile list and select a new connection profile.

Referring again to FIG. 2, in some embodiments, the connection profile list can be directly set by the user (e.g., regardless of priority) using the connection manager hook 212. In this manner, the connection mechanism described above may be overridden. The connection manager 200 supports establishment of multiple connection profiles simultaneously. However some devices do not support this functionality. In such cases, a “referee” selects between which profiles to connect. A connection referee may be implemented by the connection manager hook 212. In one exemplary embodiment, the connection manager server 202 raises a notification every time a profile is connected, disconnected or profile availability changes enabling the user to employ the connection manager hook 212.

The connection manager hook 212 may also be used to implement new mechanisms (such as automatic connection switching) and/or customized algorithms (like a custom carrier/licensee fallback mechanism), to do this the connection manager 200 may be configured so that the built-in connection algorithm is ‘hook-able’. The connection algorithm may call the connection manager hook 212 (hook function) in distinct situations. In the event of a connection request, the connection manager hook 212 may selected a connection profile to connect to and can additionally disconnect an already active connection, for example, if a carrier does not support multiple connections at a time. The connection manager hook 212 may also be called if a fallback occurs the hook function can choose the next profile to attempt connection with, overriding the default fallback mechanism, when the connection state of a connection profile changes, to maintain connectivity or establish a connection with a connection profile with higher priority. When a connection profile is connected or an error condition is reached, this allows the hook connection variables to be freed. Other situations in which the connection manager hook 212 may be called include when a connection that was not shared is made to be shared, if a connection that is shared is to be unshared. The entry point of the connection manager hook 212 may be called with a command number and parameters according to the particular situation. The function may return a hook Boolean representing the condition (hooked or not hooked) and additional parameters depending on the situation. If the condition is “not hooked”, then default built-in code may be executed.

The application level of the connection manager 202 may include a connections preferences panel 214 and a network status bar sliplet 216. The connections network panel is a user interface to the connection manager server 202, enabling the user to create, change or delete connection profiles as well as various administrative functions for the program. The network status bar sliplet 216 provides the user with the status of connections and enables the user to specify connection profiles to be connected. Although the above description may contain specific details, they should not be construed as limiting the claims in any way. Other configurations of the described embodiments of the invention are part of the scope of this invention. Accordingly, the appended claims and their legal equivalents should only define the invention, rather than any specific examples given.

What is claimed is:

1. A method of enabling an execution thread of an application running on a computing system having communication capability and a plurality of communication software modules to access a communication service that enables data communication between the computing system and a network, the method comprising:
selecting a connection profile including a sequence of references to one or more of the plurality of communication software modules for setting up a connection that uses the communication service; and
attaching the execution thread to a data channel associated with the connection profile;
wherein the selected connection profile defines steps for setting up the connection that uses the communication service.

2. The method of claim 1, further comprising
associating a connection profile stored on the computing system with one or more identifiers indicating one or more communication services which the connection profile supports.

3. The method of claim 1, further comprising:
before attaching the execution thread, determining whether a data channel associated with the selected connection profile is open and
if it is determined that a data channel associated with the selected connection profile is not open, opening a new data channel.

4. The method of claim 1, wherein the application includes a plurality of execution threads, the plurality of execution threads being attachable to distinct data channels.

5. The method of claim 1, wherein the communication service comprises a protocol for establishing communication between the computing device and a network.

6. The method of claim 1, further comprising:
detaching the thread from the data channel during execution of the thread.

7. The method of claim 1, further comprising:
defining a DNS server for each data channel;
wherein the execution thread attached to the data channel uses the DNS server defined for the data channel.

8. The method of claim 7, wherein the DNS server is associated with a virtual private network (VPN).

9. The method of claim 1, further comprising:
associating a communication host with a channel interface; and
routing traffic directed to the host through the associated channel interface.

10. The method of claim 1, further comprising:
providing a user interface enabling a user to modify the connection profile.

11. A computing system having processing capability for running an application having one or more execution threads and communication capability, the computing device comprising:
connection management logic including:
a database for storing a plurality of connection profiles;
server logic adapted to:
receive a request from the application for a communication service;
select a connection profile from the database that supports the requested communication service; and
attach one of the one or more execution thread of the application to a data channel associated with the connection profile; and
a user interface enabling user input for modifying the plurality of connection profiles.

12. The computing system of claim 11, wherein the connection management logic further includes database logic adapted to associate a connection profile stored on the computing device with one or more identifiers indicating one or more communication services which the connection profile supports.

13. The computing system of claim 11, wherein the server logic is further adapted to determine whether a data channel associated with the selected connection profile is open and to open a new channel if it is determined that a data channel associated with the selected connection profile is not open.

14. The computing system of claim 11, wherein the application run on the computing device includes a plurality of execution threads, and the server logic is adapted to attach the plurality of execution threads to distinct data channels.

15. The computing system of claim 11, wherein the requested communication service comprises a protocol for establishing communication between the computing device and a network.

16. The computing system of claim 11, wherein the server logic is further adapted to detach the one or more execution threads the data channels to which they are attached during execution.

17. The computing system of claim 11, wherein the server logic is further adapted to define a DNS server for each data channel.

18. The computing system of claim 17, wherein the DNS server is associated with a virtual private network (VPN).

19. The computing system of claim 11, wherein one or more communication hosts are associated with a channel interface in the database.

20. The computing system of claim 19, wherein the server logic is adapted to route traffic directed to a communication host through the channel interface associated with the host.
